(19) United States
(12) Patent Application Publication
(10) Pub. No.: US 2005/0129326 A1
(43) Pub. Date: Jun. 16, 2005

(54) Image processing apparatus and print system

(75) Inventor: Toru Matama, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/011,163

(22) Filed: Dec. 15, 2004

(30) Foreign Application Priority Data
Dec. 15, 2003 (JP) 2003-416866

(51) Int. Cl. G06K 9/00; G06K 9/40

(52) U.S. Cl. 382/254; 382/170; 382/162

(57) ABSTRACT

An image processing apparatus commonly used for the image processing of images for various applications, comprising: an image acquisition device which acquires an image obtained by photographing an object; an application information setting device in which the application information indicating the application of the image acquired by the image acquisition device is set; a face extracting device which extracts a facial part from the acquired image according to the application information; and an image correction device which performs the correction of the extracted facial part according to the application information.

### BACKGROUND OF THE INVENTION

1. Field of the Invention

The present invention relates to an image processing apparatus and a print system, and more particularly to an image processing apparatus and a print system which performs an image processing on images for various applications, such as identification photograph, amusement sticker, the photographic print of an image taken with a mobile phone, ordinary photographic print, etc.

2. Description of the Related Art

Images taken with a camera have various applications. Apart from an ordinary photographic print, the applications of images include, for example, the creation of a identification photograph for identifying a person and the creation of an amusement sticker obtained by printing the image of a person on a sticker paper chiefly for entertainment, as typified by Print Club (a trademark).

In recent years, as mobile phones with a built-in camera have become widely used, there is increasing the number of occasions when we take photographs by use of the mobile phones with a built-in camera. Apart from the application of displaying an image on the screen of a mobile phone or attaching an image to e-mail to send the image to another person's mobile phone, an image taken with a mobile phone with a built-in camera has the application of printing the image on a photo paper similarly to an ordinary photographic print. The demand for such a print (mobile print) is increasing.

Conventionally, taking note of the fact that emphasis is particularly on the facial part in applying corrections to the image of a person taken with a digital camera, there has been known a method of extracting the facial part from the image of a person acquired from a digital camera and then performing a color conversion processing on the resulting data so that the flesh color has a predetermined desired chromaticity value (refer to Japanese Patent Application Publication No. 2000-182043, for example.)

As the method of extracting the facial part, there are a method of specifying, by a user, the face area in the original image by use of a pointing device to recognize and extract the face area, a method of detecting a flesh-color area having a particular hue in the original image to recognize and extract the face area and other methods. On the other hand, as a method of requiring no particular operation and at the same time presuming no flesh color having a particular hue, there has been proposed an excellent method of searching for the identical or similar color area in the original image, and then determining and extracting the area corresponding to the shape of a face as the facial part from the color area thus obtained (refer to Japanese Patent Application Publication No. 5-165119.)

### SUMMARY OF THE INVENTION

The important element varies depending on the application of an image. According to prior art image processing apparatuses, however, substantially uniform processing contents are applied irrespective of the application of an image.

Commonly, a identification photograph of a person, attached to a identification, etc. serves to enable visual identification of the person. Therefore, it must be printed so that the facial part can be fundamentally compared with the real face. In addition, the finishing state of the created identification photograph, particularly that of the facial part, can affect the impression given to others about the person. Thus, for example, it is required to adjust the position of the face in the image plane and the size of the face to a predetermined setting, or to avoid the creation of a deep shadow on the face by a strobe light.

On the other hand, amusement stickers chiefly for entertainment, as typified by Print Club (a trademark), have many applications, such as creating stickers together with friends and attaching them to favorites things among friends to develop friendships, or holding them in a mini-album without attaching them to later enjoy seeing them or to show the mini-album to the third party or to give the third party's favorite stickers to the third party. Thus, the amusement stickers have not ended up as a fashion and have widely prevailed. Also in such photograph stickers, the finishing state of the facial part is of course significant, because a person is photographed. The stickers have the same objective of reproducing the image of a person as a identification photograph for identifying a person. However, the stickers are used for pleasure; therefore it is significant for the stickers to be created so that they suit the user's taste in a greater degree compared to a identification photograph. The amusement stickers are popular more among females than among males. In addition, females tend to care about the facial part more that males do. Consequently, when the finishing state of the facial part is not satisfactory, even if the stickers are created for amusement, they not only can not be enjoyed but also can make a user feel badly.

The creation of photograph prints of images taken with a silver halide camera or a digital camera is premised on such an assumption that there also exist photographs with no face photographed therein, similarly to those with only a landscape photographed therein, and also that photographs vary in the position and size of a photographed face and the mutual distance between plural photographed faces. Accordingly, to automatically perform the extraction of the facial part from such images and the image correction and at the same time improve the face detection efficiency and the print quality can require longer image processing time. In addition, there can also exist a case where a processor capable of high-speed processing can not be employed for the purpose of reducing the cost of the apparatus and other reasons. Conversely, with emphasis on high-speed processing, if the process of extracting the facial part is simplified, then the accuracy for the extraction of the facial part can be reduced; if the process of image correction is simplified, then the print quality can be reduced.

To address the above problem, an object of the present invention is to provide an image processing apparatus and a print system which can be used commonly for the processing of images for various applications and at the same time perform the image correction appropriate to the application of the corresponding image.

To implement the objective described above, according to a first aspect of the present invention, an image processing apparatus commonly used for the image processing of images for various applications comprises: an image acquisition device which acquires an image obtained by photographing an object; an application information setting device in which the application information indicating the application of the image acquired by the image acquisition device is set; a face extracting device which extracts a facial part from the acquired image according to the application information; and an image correction device which performs the correction of the extracted facial part according to the application information.

In this configuration, the facial part is extracted from the original image according to the application information set and at the same time the correction of the facial part is performed with respect to the original image according to the application information set; therefore the above apparatus can be commonly used for the processing of images for various applications, and at the same time the optimum image correction can be performed for the application of the corresponding image. In addition, since the optimum face extracting processing can be performed for each application, the accuracy for the extraction of the facial part can be improved for each application.

According to a second aspect of the invention, the image correction device in the first aspect of the invention corrects at least one of the color, brightness and aspect ratio of the extracted facial part according to the application information.

According to a third aspect of the invention, an image processing apparatus commonly used for the image processing of images for various applications comprises: an image acquisition device which acquires an image obtained by photographing an object; an application information setting device in which the application information indicating the application of the image acquired by the image acquisition device is set; a face extracting device which extracts the facial part from the acquired image according to the application information; and an image correction device which determines the correction quantity with respect to the whole of the acquired image according to the information regarding the extracted facial part and performs the correction of the whole image by use of the correction quantity.

In this configuration, the facial part is extracted from the original image according to the application information set and at the same time the correction quantity with respect to the whole image is determined according to the information regarding the extracted facial part to perform the correction of the whole image by use of the correction quantity; therefore the above apparatus can be commonly used for the processing of images for various applications, and at the same time the optimum image correction can be performed for the application of the corresponding image.

According to a fourth aspect of the invention, the image correction device in the third aspect of the invention, determines, according to the application information of the image, whether or not the cropping of the image with reference to the extracted facial part is needed, and/or calculates the optimum cropping position to perform the cropping.

According to a fifth aspect of the invention, the image correction device in the third or fourth aspect of the invention, corrects at least one of the color, brightness and aspect ratio of the whole image according to the image data of the extracted facial part.

According to a sixth aspect of the invention, the face extracting device in any one of the first to fifth aspects of the invention determines, according to the application information of the image, the maximum number of faces and/or the size of faces to extract the facial part.

In this configuration, the image processing time can be improved for applications other than ordinary photograph. Consequently, the average image processing time can be considerably improved.

According to a seventh aspect of the invention, the application information indicates whether or not a identification photograph for a single person is created, whether or not an amusement sticker in which a photograph of one or more persons is taken is created, or whether or not a photograph is created by use of an image taken with a mobile telephone.

The setting of the application information may be achieved within the image processing apparatus or may be achieved through an operation from outside the image processing apparatus. When the application information is set through an operation from outside the image processing apparatus, the application information may be acquired together with the image or separately from the image.

According to an eighth aspect of the invention, there is provided a print system comprising: the image processing apparatus according to any one of the first to seventh aspect of the invention; and a printer which prints the image processed by the image processing apparatus on a predetermined paper.

According to a ninth aspect of the invention, there is provided the print system according to the eighth aspect of the invention, further comprising a camera with which a photograph of a person is taken, the image processing apparatus performing the correction of images obtained by use of the camera.

According to the present invention, there is provided an apparatus which can be used commonly for the image processing for various applications and at the same time perform an image correction appropriate to the application of the corresponding image.

### BRIEF DESCRIPTION OF THE DRAWINGS

FIG. 1 is a block diagram showing a schematic configuration of an image processing apparatus according to an embodiment of the invention;

FIG. 2 shows a flowchart of the entire image processing in the image processing apparatus according to the embodiment of the invention;

FIG. 3 is a flowchart showing an exemplary face extraction process;

FIG. 4A is a diagram showing a two-dimensional histogram with respect to the hue level and saturation level;

FIG. 4B is a diagram showing the divided original image;

FIG. 4C is a diagram showing a single-peaked mountain captured from the two-dimensional histogram;

FIG. 5 is a flowchart showing the details of a step S108 shown in FIG. 3;

FIG. 6 is a flowchart showing the details of a step S110 shown in FIG. 3;

FIG. 7 is a flowchart showing the details of a step S172 shown in FIG. 6;

FIGS. 8A to 8G are diagrams showing a process of dividing the color area;

FIGS. 9A to 9C show an exemplary identification photograph of a person, an exemplary photograph sticker of a person and an exemplary ordinary photograph print, respectively.

FIGS. 10A to 10C are diagrams used to explain the cropping of images;

FIG. 11 is a block diagram showing Embodiment 1 of the print system to which the image processing apparatus according to the invention is applied; and

FIG. 12A to 12C are block diagrams showing Embodiment 2 of the print system to which the image processing apparatus according to the invention is applied.

### DETAILED DESCRIPTION OF THE PREFERRED EMBODIMENTS

Detailed descriptions will be given below of preferred embodiments to implement the present invention with reference to the attached drawings.

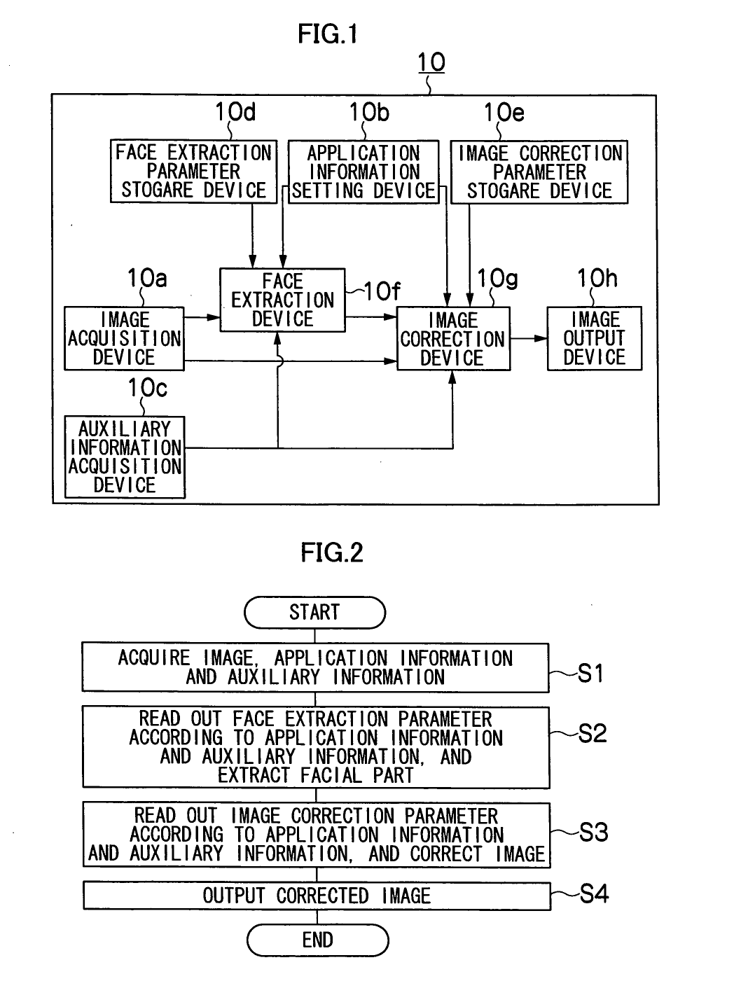

FIG. 1 is a block diagram showing a schematic configuration of an image processing apparatus according to an embodiment of the invention. Referring to FIG. 1, an image processing apparatus 10 is an apparatus used commonly for the image processing of images for various applications, which apparatus mainly comprises an image acquisition device 10a, an application information setting device 10b, an auxiliary information acquisition device 10c, a face extraction parameter storage device 10d, an image correction parameter storage device 10e, a face extracting device 10f, an image correction device 10g and an image output device 10h.

The image acquisition device 10a serves to acquire an image obtained by photographing an object. There are various forms of image acquisition by the image acquisition device 10a, which forms include, for example: direct acquisition of images through direct communication with a camera; reading images from a storage medium such as a memory card where the images are stored by use of a mobile telephone with a built-in camera or a digital still camera, etc.; receiving images through a network such as the Internet; and reading images from a photographic film where the images are stored by use of a silver halide camera. These forms of image acquisition are not particularly limited thereto. In addition, there is no particular limitation to the image data format. However, descriptions will be given below, assuming that an image is acquired by use of digital data which represent the image by each color of R (red), G (green) and B (blue).

The application information setting device 10b serves to set the application information. Here, the application information means the information indicating the application of an image to be processed, i.e. an image acquired by the image acquisition device 10a. There will be described below a case indicating any one of: the creation of a identification photograph for a given person (referred to below as “identification photograph” for short); the creation of an amusement sticker obtained by printing an image of one or more given persons on a sticker paper primarily for entertainment (referred to below as “photograph sticker”), as typified by “Print Club” (a registered trademark); the creation of a photograph whose original image is an image taken with a mobile phone with a built-in camera (referred to below as “mobile print”); and the creation of a photograph whose original image is an image taken with an ordinary camera such as a digital still camera and a silver halide camera (referred to below as “ordinary photograph print”).

The auxiliary information acquisition device 10c serves to acquire the auxiliary information regarding an image acquired by the image acquisition device 10a. The auxiliary information includes: the image photographing conditions such as the presence of strobe lighting, the kind of a strobe light, the maker of a strobe, etc.; and the client information such as the sex, age, nationality and taste of a client being an object. There are two forms of acquisition of the auxiliary information; extraction of the auxiliary information attached to the image and acquisition of the auxiliary information separately from the image. For example, when an image is generated in Exif (Exchangeable Image Format) and the auxiliary information is attached to the image as tag information, the auxiliary information can be acquired and extracted together with the image. Alternatively, the photographing conditions can be directly acquired from the camera and at the same time the client information can be acquired through an operation panel operated by the client, such as a touch panel, for example.

The face extraction parameter storage device 10d serves to store, for each application of images, parameters required for face extraction by the later-described face extracting device 10f (referred to as “face extraction parameters”). In addition, further detailed parameters related to various auxiliary information may be stored. The face extraction parameters include, for example: the maximum number of faces to be included in the original image (“1” for identification photograph, “1 to 5” for photograph sticker, an unspecified number for ordinary photograph print, etc, for example); the allowable range of sizes of the facial parts to be included in the original image; the range of the color (hue level, saturation level) and brightness (lightness level) of the faces on the original image; data regarding the outline and internal structure of the faces; and factors calculated with respect to each parameter according to the photographing conditions (the presence of strobe lighting, the kind of a strobe, the maker of a strobe, for example) and the client information (the sex, age, nationality, taste, for example).

The image correction parameter storage device 10e serves to store, for each application of images, parameters required for image correction by the later-described image correction device 10g (referred to as “image correction parameters”). In addition, further detailed parameters related to various auxiliary information may be stored. The image correction parameters include, for example: parameters required for the cropping of the original image with reference to the facial part; parameters required for the correction of the color (hue, saturation) and brightness (lightness) of the facial part; parameters required for the correction of the color (hue, saturation) and brightness (lightness) of the whole image; parameters required for the correction of the aspect ratio, such as the correction for making the facial part slender; parameters required for the correction of the aspect ratio of the whole image; and factors calculated with respect to each parameter according to the photographing conditions and the client information.

The face extracting device 10f serves to read out from the face extraction parameter storage device 10d the face extraction parameters appropriate to the acquired image according to the application information, and extract the facial parts from the original image by use of the face extraction parameters. According to the auxiliary information as well as the application information, the face extraction parameters may be selected to extract the facial parts.

For example, according to the application information, the maximum number of faces and the size of faces are determined to extract the facial parts. The maximum number of faces is set, for example, to one for identification photograph, set to 1 to 5 for photograph sticker and set to an unspecified number for other types to extract the facial parts. As for the size of faces, the ratio between the size of faces and the whole size of the acquired original image is determined to extract the facial parts for a identification photograph, a photo seal, a mobile print and a general photo print. As for identification photograph and photograph sticker in particular, the proportion of the facial parts with respect to the whole size of the original image is assumed to be larger in this order; thus the size of faces is determined to exclude the smaller objects and larger objects compared to a predetermined range as ones being not a face from the objects to be extracted.

The image correction device 10g serves to read out from the image correction parameter storage device 10e the image correction parameters appropriate to the acquired image according to the application information and perform the correction of the original image by use of the image correction parameters. According to the auxiliary information as well as the application information, the image correction may be performed.

For example, it is determined, according to the application information, whether or not an image cropping performed with reference to the facial part is needed, and at the same time the optimum cropping position is calculated to perform the cropping. Particularly, for identification photograph, the periphery of the image is cut away with reference to the facial part. Also for photograph sticker, the cropping may be performed with reference to one or more facial parts.

In addition, it is determined, according to the application information, whether or not each correction with respect to the color, brightness and aspect ratio of the facial part is needed, and then the correction is performed on the image. In the color correction, the hue and saturation are adjusted for each pixel constituting the image. In the brightness correction, the lightness (or density, luminance) is adjusted for each pixel constituting the image. In the aspect ratio correction, the aspect ratio of the facial part is changed so that the face is made slender. In this case, by specifying the cheek part of the face, only the cheek part may be made slender.

In addition, the color, brightness and aspect ratio of the whole image are corrected according to the image data of the extracted facial part. For example, when no correction is performed, if the photograph is taken against the light, the face will turn dark; if the proximity strobe flashing mode is employed, the face will turn excessively white. Thus, according to the density level (indicating the brightness) of the extracted facial part, the optimum correction quantity of the density level with respect to the face is calculated to perform the correction of the whole image, thereby implementing more appropriate finishing state.

When a different kind of light source (fluorescent light, tungsten lamp) is employed for photographing, the color balance will be changed. Thus, the color correction quantity for each of C (Cyan), M (Magenta) and Y (Yellow) is calculated so that the extracted facial part has the optimum flesh color, and then the correction of the whole image is performed, thereby implementing more appropriate finishing state.

The image output device 10h serves to output the image corrected by the image correction device 10g. There are various forms of image output by the image output device 10h, which forms include, for example: sending of the image to a printer and printing of the image on a given paper by the printer; printing directly of the image on a given paper; storing of the image into a storage medium such as memory card, CD-ROM, etc.; sending of the image via a network; and displaying of the image. Such forms of image output are not limited thereto.

A description will now be given of a flow of the image processing in the image processing apparatus 10 described above.

FIG. 2 shows a flow of the whole image processing in the image processing apparatus 10. Referring to FIG. 2, firstly the image acquisition by the image acquisition device 10a, the application information acquisition by the application information setting device 10b and the auxiliary information acquisition by the auxiliary information acquisition device 10c are performed (S1). Subsequently, the face extraction parameters appropriate to the acquired image are read from the face extraction parameter storage device 10d according to the application information and auxiliary information, and the facial part is extracted from the acquired image by use of the face extraction parameters (S2). Then, the image correction parameters appropriate to the acquired image are read from the image correction parameter storage device 10e according to the application information and auxiliary information, and the correction of the acquired image is performed by use of the image correction parameters (S3). The corrected image is output (S4).

Firstly a description will be given of the face extraction when the application information of the image indicates ordinary photograph print.

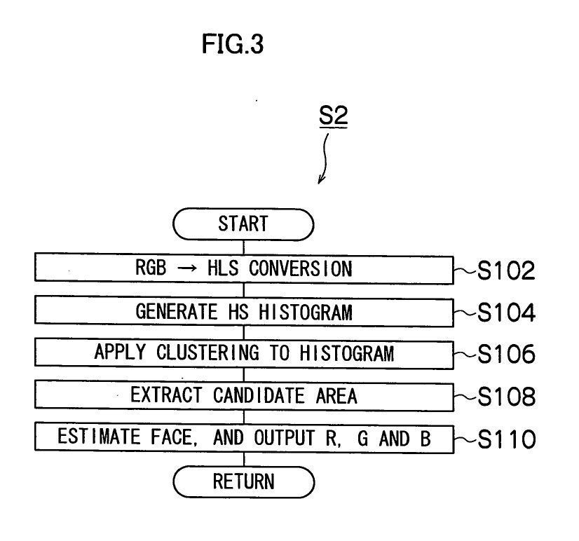

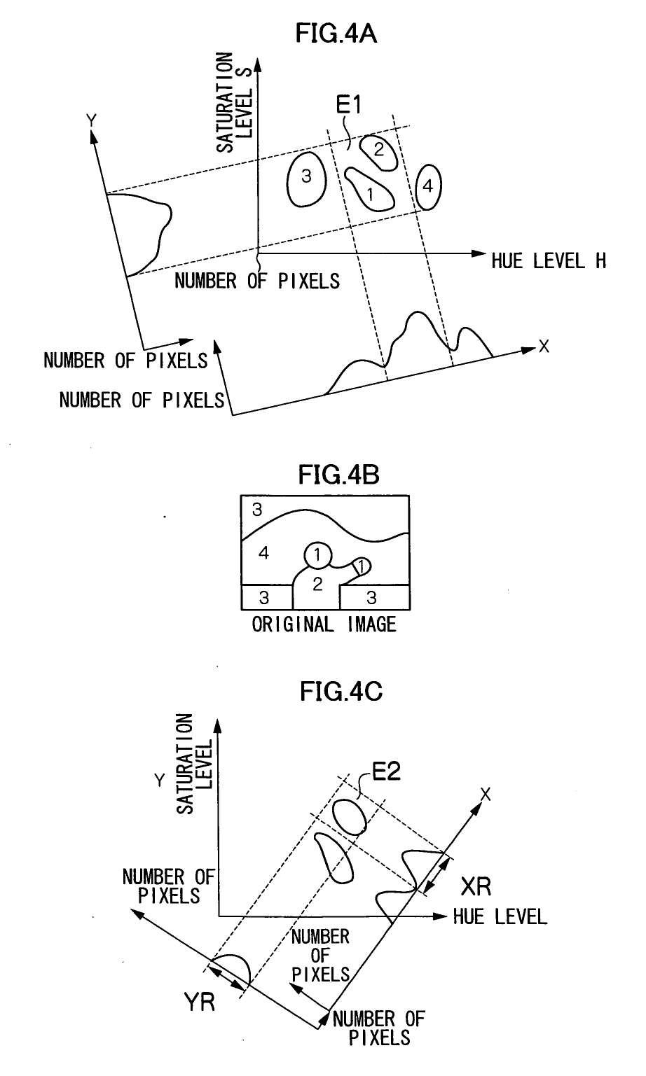

FIG. 3 shows the specific contents of the face extraction process (S2) shown in FIG. 2. Firstly in a step S102, the image represented by each color of R, G and B is converted into the image represented by H (hue level), L (lightness level) and S (saturation level). In a step S104, as shown in FIG. 4A, a two-dimensional histogram with respect to hue level and saturation level is determined by use of the coordinate system consisting of hue axis, saturation axis and pixel number axis, which are orthogonal to each other. Then, in a step 106, the determined two-dimensional histogram is divided for each mountain. Specifically, clustering of the two-dimensional histogram is performed. Then, in a step S108, clustering with respect to many pixels is performed based on the mountains obtained by applying clustering to the two-dimensional histogram, and the image plane is divided according to the clustering. Then, the areas corresponding to the human face candidates are extracted from the divided areas. Subsequently, in a step S110, the color areas extracted as the face candidates are further divided into circular or oval areas, and the face areas are estimated according to the divided areas.

FIG. 4A shows the two-dimensional histogram determined in the step S104 shown in FIG. 3 and the mountains captured in the step S106 shown in FIG. 3. In the example shown in FIG. 4A, when viewed from a direction orthogonal to the X axis, the mountains with reference numerals 1 and 2 affixed thereto are seen overlapping each other; therefore three mountains, i.e. a mountain with numeral 3, a mountain with numerals 1 and 2, and a mountain with numeral 4 appear in the X-axis histogram (one-dimensional histogram). On the other hand, when viewed from a direction orthogonal to the Y axis, the mountains with numerals 1 to 4 are seen overlapping each other; therefore a single mountain appears in the Y-axis histogram (one-dimensional histogram). In each of the X-axis histogram and Y-axis histogram, the mountains are captured to determine the areas where the mountains overlap each other. E1 shown in FIG. 4A shows an example of the areas including the mountains thus captured. It is determined whether or not the captured mountain is of single-peaked pattern. Since the area E1 is not of single-peaked pattern, the determination of a two-dimensional histogram is repeated to capture the mountain area of a single-peak pattern. An area E2 shown in FIG. 4C shows an example of a mountain area of a single-peak pattern thus captured.

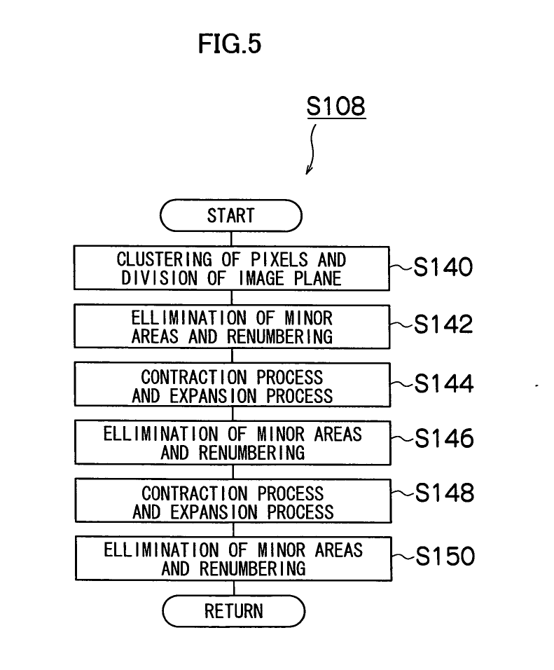

FIG. 5 shows the details of the step S108 shown in FIG. 3. In a step S140, a range XR (FIG. 4C) in the X-axis direction and a range YR (FIG. 4C) in the Y-axis direction are determined for each single-peak mountain. Then, with respect to each pixel of the original image, it is determined whether or not the hue level and saturation level belong in the above ranges, thus performing the clustering of the pixels. At the same time, the pixels belonging in the range surrounded by the ranges XR and YR are grouped, and the original image is divided so that the grouped pixels make up a single area on the original image. Numbering is performed for each area obtained by the division. In FIG. 4B showing an example where the original image is divided, the pixels of each area having numerals 1 to 4 correspond to those included in the single-peaked mountains having numerals 1 to 4 shown in FIG. 4A. Referring to FIG. 4B, the pixels belonging in the same single-peaked mountain of FIG. 4A is divided into different areas in FIG. 4B. This is because the pixels are divided into different areas on the original image shown in FIG. 4B while belonging in the hue and saturation ranges of a single-peaked mountain in FIG. 4A. Subsequently, in a step S142, the size of each area obtained by the division is determined to eliminate minor areas, and then renumbering is performed. Subsequently, in a step S144, a contraction process of eliminating all boundary pixels of an area to slightly shrink the area, and on the contrary an expansion process of spreading the boundary pixels of an area in a direction of background pixels to slightly expand the area are performed to separate small areas connected to large areas from the large ones. Subsequently, in a step S146, similarly to the step S142, the minor areas are eliminated and then renumbering is performed. In a step S148, the contraction and expansion processes similar to the above described processes are performed to separate areas having a weak bond with each other. Then, in a step S150, the elimination of minor areas and renumbering are performed similarly to the above described processes.

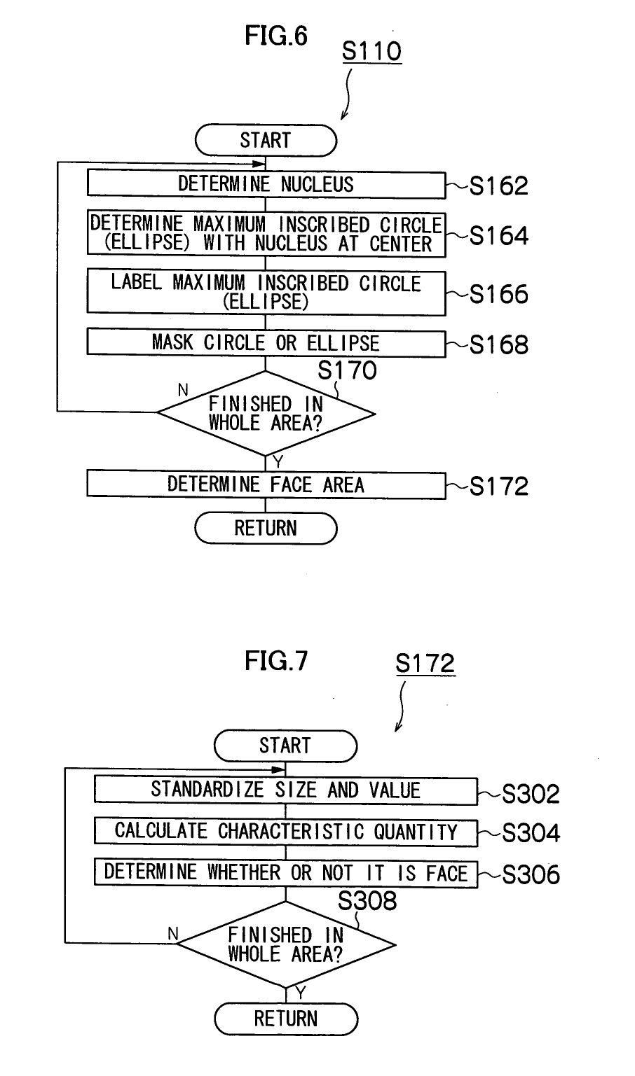

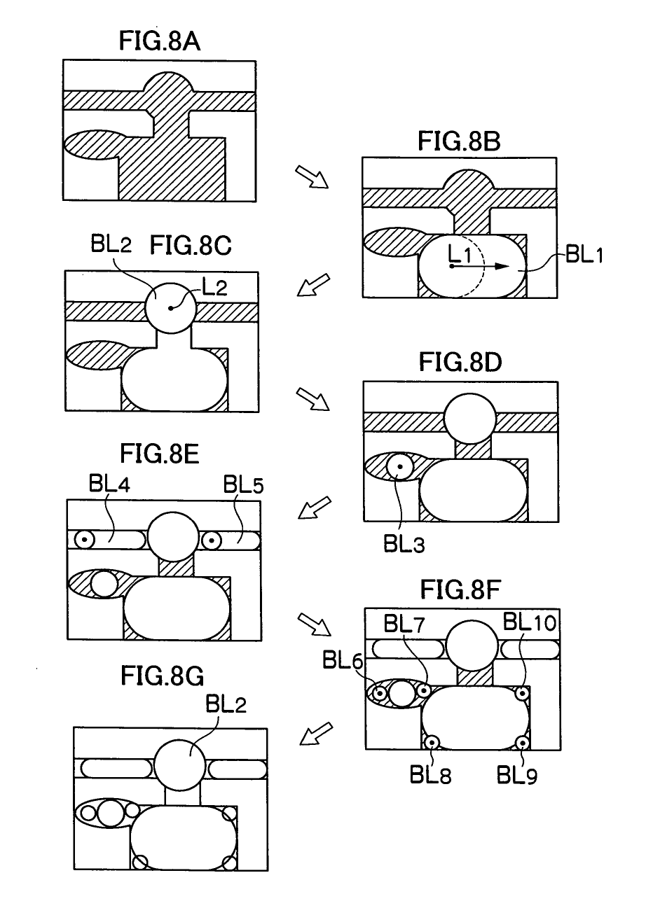

FIG. 6 shows the details of the step S110 shown in FIG. 3. For the purpose of explaining the step S110 in detail, a description will be given below with reference to an image shown in FIG. 8A, where the areas having the color identical or similar to that of the face exist extensively. For identification photograph or photograph sticker, the color area shown in FIG. 8A, having the color identical or similar to that of the face can be set narrowly compared to other applications. This is because a photograph is taken under fixed lighting conditions. Narrow setting leads to increased accuracy for face extraction and shorter extraction processing time.

Firstly in a step S162, a single area is selected from the areas extracted in the routine of FIG. 5 as the area of note (the step S108) (refer to FIG. 8A). Then, the selected area of note is contracted to determine a nucleus used to disintegrate the area of note. Specifically, the contraction process of eliminating the boundary pixels of the area of note is repeated and a resultant single area of point-like or linear shape is set as the nucleus. As shown in FIG. 8B, the above linear area is a set of plural contiguous points (a pixel or a set of plural pixels), i.e. a line L1. In this case, the image to be processed, which is based on the original image consisting of preliminarily quantized digital data, is not continuous, but discrete; therefore the above nucleus has an area of a certain size. According to the shape of the image to be processed, there can be a plurality of resultant nuclei. In this case, an area having the minimum size is set as the nucleus. If plural areas of the same size remain, then any arbitrary area is selected. Subsequently, in a step S164, a circle or an ellipse inscribed in the area of note and having the maximum size is determined by use of the nucleus thus determined as the center of the circle or the ellipse. Specifically, by repeating the expansion process by use of the nucleus as the center by the same number of times as when the contraction process is repeated to determine the nucleus, an inscribed circle is determined for the point-like nucleus; an inscribed ellipse is determined for the linear nucleus. After determining the circle or ellipse inscribed in the area of note and having the maximum size, the flow proceeds to a step S166. In the step S166, there is performed a process (labeling) of attaching a label for identifying the determined circle having the maximum size (or an ellipse based on the circle). In a subsequent step S168, the labeled circle or ellipse area BL1 is masked, and then the flow proceeds to a step S170. Subsequently, in the step S170, it is determined whether or not the division performed by use of a circular or oval area is completed with respect to all the extracted areas. Then, if not, the steps S162 to S168 are repeated. Accordingly, as shown in FIGS. 8B to 8F, the division into areas BL1 to BL10 is performed in order of circular size. After the division of the area of note is finished, the flow proceeds to a step S172. In the step S172, at least one of the circles or ellipses obtained by the division is selected to estimate the face area. The details of the process are later described.

FIG. 7 shows the details of the step S172 in FIG. 6. In a step S302, a single area is selected as a characteristic area from the circular or oval areas described above. Then, there is performed a process of expanding/contracting the characteristic area so that the horizontal fillet diameter and vertical fillet diameter of the characteristic area are adjusted to a predetermined value, thereby standardizing the size of the characteristic area. At the same time, the lightness level (or density level, luminance level) is standardized. Then, in a step S304, the correlation coefficients of the characteristic area with respect to preliminarily stored plural (10 kinds in the embodiment) standard face images (frontal view, left-side and right-side view, downward view, upward view, etc.) are calculated; the correlation coefficients are set as characteristic quantity. The standard face images may be data regarding only the outline of a face, or may be data obtained by adding the internal structure data (eyes, nose, mouth, etc.) to the face outline data. In a step S306, it is determined whether or not the characteristic area is a human face by use of linear discriminant analysis which employs the above characteristic quantity as variables. In a step S308, it is determined whether or not the determination of a face is finished with respect to all the areas obtained by the division. Then, if not, the steps S302 to S308 are repeated. In the embodiment, the correlation coefficient is employed as the characteristic quantity for the determination of a face. However, an invariant derived from the central moment standardized with respect to the median point, an auto-correlation coefficient or a geometric invariant may also be employed.

According to the face extraction described with reference to the above-described FIGS. 3 to 8, it is not required for a user to specify the face area of the original image. In addition, the face area can be extracted without assuming that there exists a flesh color with a particular hue in the original image. Even when plural faces are included in the original image, the face extraction can be performed with satisfactory detection efficiency. However, when an improvement in the apparatus design is carried out to increase the face detection number, the number of overcorrected areas can adversely increase due to erroneous detection. On the other hand, even if the detection efficiency is satisfactory, the detection speed can be low, which is not practical. Employment of a high-performance processor may be useful. However, even when a high-performance processor can not be employed for the image processing due to the cost reduction for an apparatus and other reasons, it is necessary to avoid the decreasing of speed.

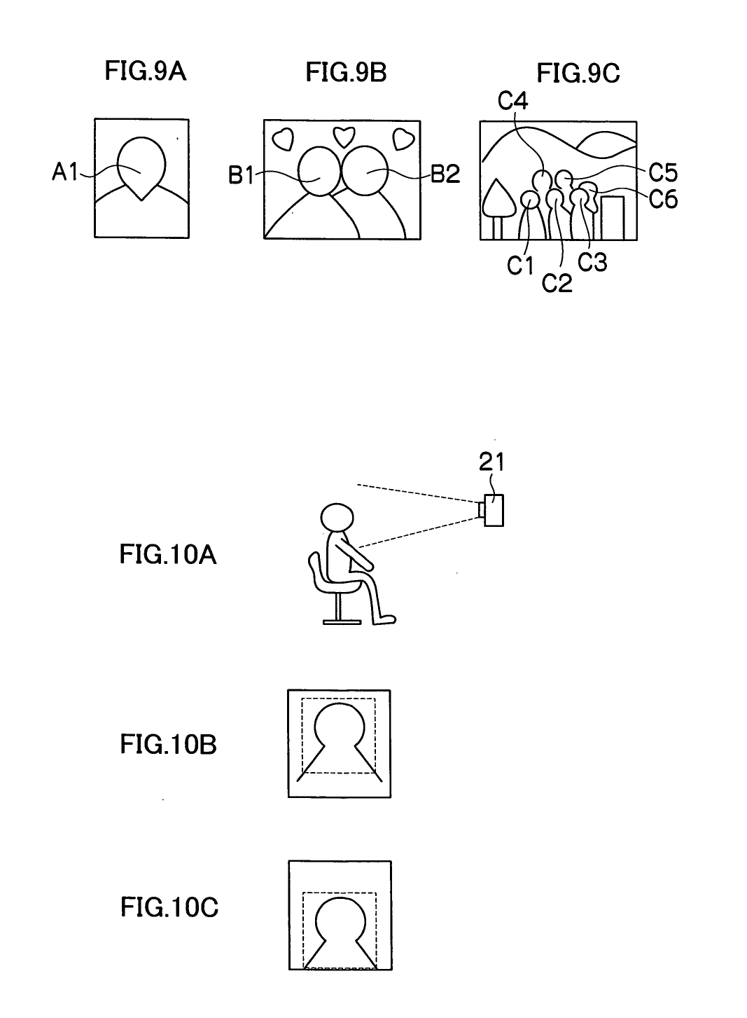

Here, attention is focused on the fact that if the average image processing time is improved, the speed can be substantially increased in practice. In addition, attention is focused on the application of an image. For example, in an exemplary identification photograph shown in FIG. 9A, there is only one face (A1). In an exemplary photograph sticker shown in FIG. 9B, there are two faces (B1 and B2). In an exemplary ordinary photograph print shown in FIG. 9C, there are six faces (C1 to C6). Generally, a identification photograph includes one face; a photograph sticker includes one to five faces; an ordinary photograph includes many faces, but no face can be included in a landscape photograph. Accordingly, for identification photograph and photograph sticker, the maximum number of faces may be limited for face extraction. In addition, for identification photograph and photograph sticker, the size of faces may be limited for face extraction. As a result of the study on many images taken with mobile phones, it is known that in mobile prints, more face images can be included compared to ordinary photographs and the size of faces can be larger compared to ordinary photographs. Consequently, specifically, in the face extraction process described with reference to FIGS. 3 to 8, when the application information indicates identification photograph, photograph sticker or mobile print, the maximum number of faces and the size of faces can be limited for face extraction. More specifically, in the face extraction process, the size of areas to be processed in each step is compared with the range from the minimum value to the maximum value regarding the size of faces, which is predetermined for each application. Any areas having sizes outside the above range are sequentially eliminated. On the other hand, the number of extracted faces is compared with the maximum number of faces, which is predetermined for each application; when the relevant maximum number is reached, the face extraction is halted so as not to exceed the relevant maximum number. The maximum number of faces and the range of the size of faces for each application are preliminarily stored as the face extraction parameters in the face extraction parameter storage device 10d.

Limiting of the maximum number of faces and the size of faces for each application in the face extraction process was described above. However, the process above described is not limited thereto. For example, when it is supposed that the photographing conditions (the presence of strobe lighting, the kind of a strobe light, the maker of a strobe) are fixed for each application, the face extraction may be performed by use of parameters which are based on the above photographing conditions for each application. Alternatively, the face extraction may be performed according to the auxiliary information acquired by the auxiliary information acquisition device 10c, such as the auxiliary information extracted from the image generated in Exif data format, the auxiliary information acquired directly from the camera, and the auxiliary information input by a client from the operation panel.

Next, a description will be given of the image correction for each application of images.

In the step S3 of FIG. 2, it is determined for each application of images whether or not the cropping of the image with reference to the facial part is required, and at the same time the optimum cropping position is calculated to perform the cropping. Specifically, for identification photograph, the periphery of the image is cut away with reference to the facial part. FIG. 10A shows a case where a identification photograph is taken. As shown in FIG. 10B, for taller persons, the photograph is often taken with the face located in the upper side of the image. On the other hand, for shorter persons, as shown in FIG. 10C, the photograph is often taken with the face located in the lower side of the image. Even when the height of the chair on which the person to be photographed sits is adjustable, the variation in height often occurs. Since the adjustment of the height of the chair is complex, it is more convenient for a user to make the photographing range wider and after taking the photograph, trim the image so that the face is located at the center. According to the embodiment, when the application information indicates identification photograph, it is determined that the cropping of the image with reference to the facial part is needed, and the periphery of the original image is cut away with reference to the facial part extracted by the face extraction device 10f. Also for photograph sticker, the cropping may be performed with reference to one or more facial parts.

In the step S3 of FIG. 2, it is determined for each application of images whether or not each correction of the color, brightness and aspect ratio of the facial part is required, and these corrections are made on the image. In the color correction, the hue and saturation are adjusted for each pixel constituting the image. In the brightness correction, lightness (or density, luminance) is adjusted for each pixel constituting the image. In the aspect ratio correction, the aspect ratio of the facial part is modified so that the face is made slender. In this case, by specifying the cheek part of the face, only the cheek part may be made slender.

The color, brightness and aspect ratio of the whole image are corrected according to the image data of the extracted facial part.

Alternatively, the image correction may be made based on the auxiliary information acquired by the auxiliary information acquisition device 10c, such as the auxiliary information extracted from the image generated in Exif data format, the auxiliary information acquired directly from the camera, and the auxiliary information input by a client from the operation panel.

Even when a taken photograph seems to correctly reproduce the object in the third party's eyes, the photograph may not suit the taste of the user itself being the object and thus the user may want the overcorrection of the image. Therefore, according to the application of the image, for example, when the applications other than identification photograph are specified, the image correction may be made as indicated by a user from the operation panel. For example, the user may specify the correction level regarding the brightness of the facial part and then the brightness of the whole image or the facial part is corrected in accordance with the above specified level. In addition, in the applications other than identification photograph, for example, a user may specify the correction level regarding the aspect ratio and then the face, only the cheek part of the face, or the whole body may be corrected in accordance with the above specified level; the above correction can be excessively made as long as the print looks correct and favorable in the user's eyes, even though the print looks slightly different from the real person in the third party's eyes. On the other hand, the switching of the image correction parameters may be performed for each application; in the application of identification photograph, restrictions are preferably imposed to avoid an overcorrection.

The case in which the maximum number of faces and the size of faces are limited to extract the faces and other cases were described in this embodiment, but the invention is not limited the above described cases; it will easily be appreciated that other face extraction parameters may be switched for each application of images.

The case in which the cropping of an image is performed according to the application of the image, the case in which the color, brightness and aspect ratio of an image are corrected according to the application of the image, and other cases were described in this embodiment, but the invention is not limited the above described cases; it will easily be appreciated that other image correction parameters may be switched for each application of images.

The application of an image is not limited to identification photograph, photograph sticker, mobile print and ordinary photograph print.

### Embodiment 1

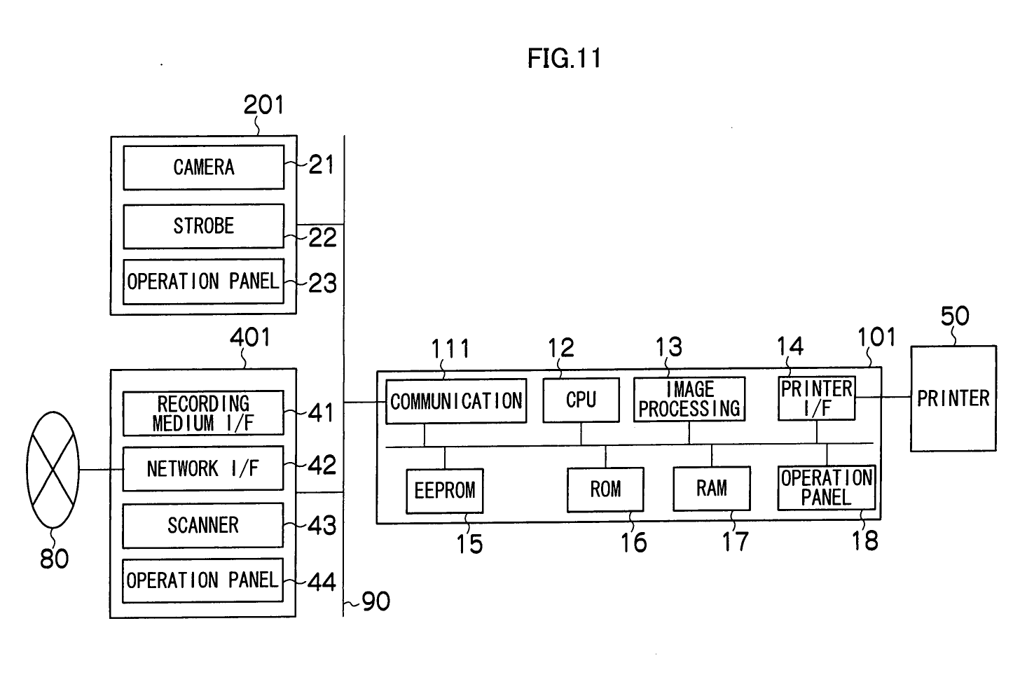

FIG. 11 shows a case in which the invention is applied to a print system capable of performing both the creation of identification photographs and the printing of mobile prints and ordinary photograph prints.

The print system shown in FIG. 11 mainly comprises: a identification photograph-taking apparatus 201; a photograph print accepting apparatus 401; an image processing apparatus 101 of Embodiment 1 which performs image processing on the images acquired via LAN 90 (Local Area Network) from the identification photograph-taking apparatus 201 and the photograph print accepting apparatus 401; and a printer 50 which prints the images processed by the image processing apparatus 101 on a predetermined paper.

The identification photograph-taking apparatus 201 mainly includes: a camera 21 which photographs a person as the object of a identification photograph; a strobe 22 which illuminates the object person with flashlight; and an operation panel 23 which a user operates.

The photograph print accepting apparatus 401 serves to accept the photograph printing of images taken by a user with a mobile telephone with a built-in camera, a digital still camera or a silver halide camera, etc, and includes: a storage medium interface 41 which reads the images from a storage medium such as a memory card; a network interface 42 which receives the user images via the Internet 80; a scanner 43 which reads the user images from the films of silver halide cameras; and an operation panel 44 which a user operates.

The image processing apparatus 101 is used commonly in each application of identification photograph, mobile print and ordinary photograph print, and mainly comprises: a communication circuit 111 which receives images from the identification photograph-taking apparatus 201 and the photograph print accepting apparatus 401; CPU 12 (Central Processing Unit) which supervises and controls each unit of the image processing apparatus 101 and at the same time performs the face extraction process; an image processing circuit 13 which performs the image correction process, etc.; a printer interface 14 which sends the corrected images to the printer 50; EEPROM 15 (Electrically Erasable and Programmable ROM) which stores various kinds of setting information; ROM 16 (Read Only Memory) which stores programs executed by the CPU 12 and the like; RAM 17 (Random Access Memory) used as working memory during program execution; and an operation panel 18 which a user operates.

In Embodiment 1, the application information is set via the LAN 90 from the identification photograph-taking apparatus 201 and the photograph print accepting apparatus 401. Specifically, through the control from the CPU 12, the application information received via the communication circuit 111 from the identification photograph-taking apparatus 201 or the photograph print accepting apparatus 401 is stored into the RAM 17; the face extraction and image correction are performed based on the above application information stored in the RAM 17.

The correspondence between the elements of the image processing apparatus 101 of Embodiment 1 shown in FIG. 11 and the elements of the image processing apparatus 10 schematically shown in FIG. 1 will now be briefly explained. The image acquisition device 10a and the auxiliary information acquisition device 10c mainly comprise the communication circuit 111. The application information setting device 10b mainly comprises the communication circuit 111, the CPU 12 and the RAM 17. The face extraction parameter storage device 10d and the image correction parameter storage device 10e shown in FIG. 1 mainly comprise the EEPROM 15. The face extracting device 10f shown in FIG. 1 mainly comprise the CPU 12. The image correction device 10g shown in FIG. 1 mainly comprises the CPU 12 and the image processing circuit 13. The image output device 10h shown in FIG. 1 mainly comprises the printer interface 14.

### Embodiment 2

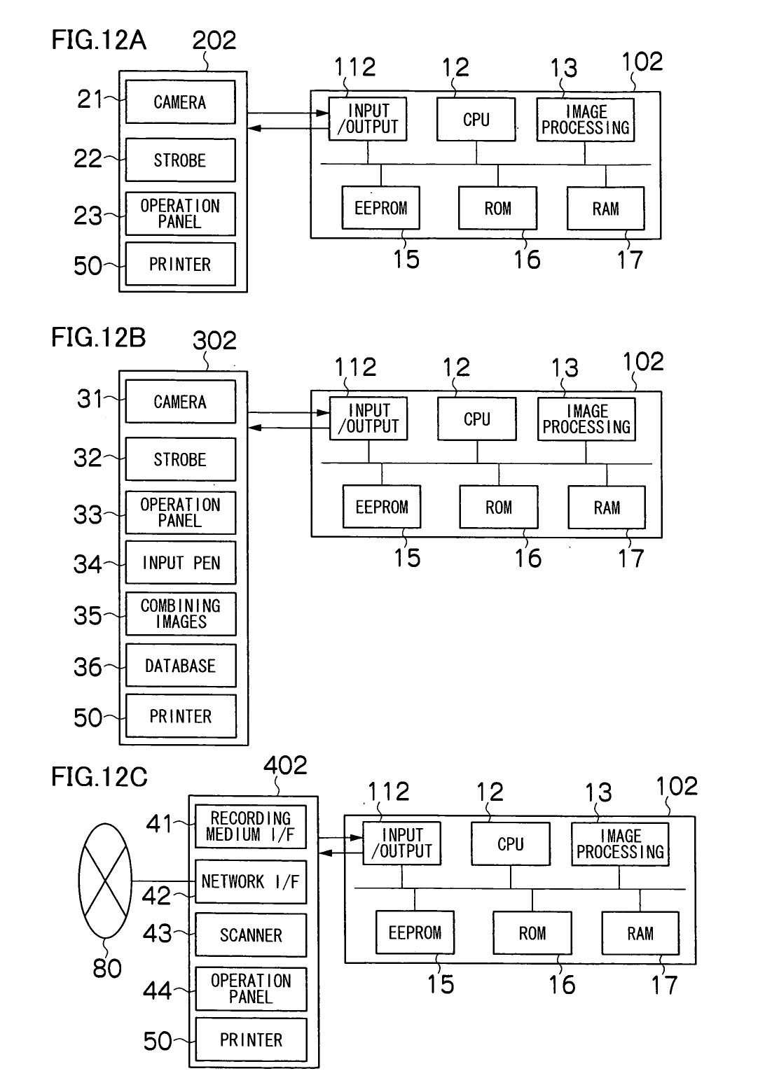

FIG. 12A shows a case in which the invention is applied to a print system for identification photograph. FIG. 12B shows a case in which the invention is applied to a print system for photograph sticker. FIG. 12C shows a case in which the invention is applied to a print system for mobile print and ordinary photograph print.

In the print system for identification photograph shown in FIG. 12A, which is a single-purpose system exclusively for the creation of identification photograph, a identification photograph-taking apparatus 202 mainly includes: a camera 21 which photographs a person as the object of identification photograph; a strobe 22 which illuminates the object person with flashlight; an operation panel 23 which a user operates; and a printer 50 which prints the images on a predetermined paper. Connected to the identification photograph-taking apparatus 202 is an image processing apparatus 102 which performs the image processing on the images input from the identification photograph-taking apparatus 202. The image processing apparatus 102 may be installed into the identification photograph-taking apparatus 202.

In the print system for photograph sticker shown in FIG. 12B, which is a single-purpose system exclusively for the creation of photograph sticker, a photograph sticker creating apparatus 302 mainly includes: a camera 31 which photographs a person as the object of photograph sticker; a strobe 32 which illuminates the object person with flashlight; an operation panel 33 used to input the instructions and monitor the images; an input pen 34 used to input sketch images with pen; an image composition circuit 35 which combines the original image taken with the camera 31 with decorative images such as the sketch images, template images, etc.; a database 36 which stores the template images; and a printer 50 which prints the images on a predetermined paper. Connected to the photograph sticker creating apparatus 302 is an image processing apparatus 102 which performs the image processing on the images input from the photograph sticker creating apparatus 302. The image processing apparatus 102 may be installed into the photograph sticker creating apparatus 302.

In the print system for mobile print and ordinary photograph print shown in FIG. 12C, which is a single-purpose system exclusively for the printing of mobile print and ordinary photograph print, a photograph print accepting apparatus 402 mainly includes: a storage medium interface 41 which reads the images from a storage medium such as a memory card; a network interface 42 which receives the user images via the Internet 80; a scanner 43 which reads the user images from the films of silver halide cameras; and an operation panel 44 which a user operates; and a printer 50 which prints the user images on a print paper. Connected to the photograph print accepting apparatus 402 is an image processing apparatus 102 according to the embodiment. The image processing apparatus 102 may be installed into the photograph print accepting apparatus 402.

The image processing apparatus 102 is commonly employed in A, B and C of FIG. 12. More specifically, the image processing apparatus 102 is employed commonly in the creation of identification photograph, the creation of photograph sticker and the printing of mobile print and ordinary photograph print. The image processing apparatus 102 mainly comprises: an input/output circuit 112 which inputs the original image and outputs the corrected images; CPU 12 which supervises and controls each unit of the image processing apparatus 102 and at the same time performs the face extraction process; an image processing circuit 13 which performs the image correction process, etc.; EEPROM 15 in which the application information, etc. are set; ROM 16 which stores programs executed by the CPU 12 and the like; and RAM 17 used as working memory during program execution.

In Embodiment 2, the application information is preliminarily set in the EEPROM 15, or alternatively set from the identification photograph-taking apparatus 202, the photograph sticker creating apparatus 302 or the photograph print accepting apparatus 402. Specifically, the application information received via the communication circuit 111 from the identification photograph-taking apparatus 202, the photograph sticker creating apparatus 302 or the photograph print accepting apparatus 402 is stored in the EEPROM 15; the face extraction and image correction are performed based on the above application information stored in the EEPROM 15. Alternatively, a maintenance panel (or a computer unit for maintenance) (not shown) may be connected to the image processing apparatus 102 to set the application information.

The correspondence between the elements of the image processing apparatus 102 of Embodiment 2 commonly employed in each print system shown in FIGS. 12A, 12B and 12C and the elements of the image processing apparatus 10 schematically shown in FIG. 1 will now be briefly explained. The image acquisition device 10a and the auxiliary information acquisition device 10c mainly comprise the input/output circuit 112. The application information setting device 10b mainly comprises the EEPROM 15. The face extraction parameter storage device 10d and the image correction parameter storage device 10e shown in FIG. 1 mainly comprise the EEPROM 15. The face extracting device 10f shown in FIG. 1 mainly comprise the CPU 12. The image correction device 10g shown in FIG. 1 mainly comprises the CPU 12 and image processing circuit 13. The image output device 10h shown in FIG. 1 mainly comprises the input/output circuit 112.

1. An image processing apparatus commonly used for the image processing of images for various applications, comprising:
an image acquisition device which acquires an image obtained by photographing an object;
an application information setting device in which the application information indicating the application of the image acquired by the image acquisition device is set;
a face extracting device which extracts a facial part from the acquired image according to the application information; and
an image correction device which performs the correction of the extracted facial part according to the application information.

2. The image processing apparatus according to claim 1, wherein the image correction device corrects at least one of the color, brightness and aspect ratio of the extracted facial part according to the application information.

3. An image processing apparatus commonly used for the image processing of images for various applications, comprising:
an image acquisition device which acquires an image obtained by photographing an object;
an application information setting device in which the application information indicating the application of the image acquired by the image acquisition device is set;
a face extracting device which extracts the facial part from the acquired image according to the application information; and
an image correction device which determines the correction quantity with respect to the whole of the acquired image according to the information regarding the extracted facial part and performs the correction of the whole image by use of the correction quantity.

4. The image processing apparatus according to claim 3, wherein the image correction device determines, according to the application information of the image, whether or not the cropping of the image with reference to the extracted facial part is needed, and/or calculates the optimum cropping position to perform the cropping.

5. The image processing apparatus according to claim 3, wherein the image correction device corrects at least one of the color, brightness and aspect ratio of the whole image according to the image data of the extracted facial part.

6. The image processing apparatus according to claim 4, wherein the image correction device corrects at least one of the color, brightness and aspect ratio of the whole image according to the image data of the extracted facial part.

7. The image processing apparatus according to claim 1, wherein the face extracting device determines, according to the application information of the image, the maximum number of faces and/or the size of faces to extract the facial part.

8. The image processing apparatus according to claim 3, wherein the face extracting device determines, according to the application information of the image, the maximum number of faces and/or the size of faces to extract the facial part.

9. The image processing apparatus according to claim 1, wherein the application information indicates whether or not a identification photograph of a single person is created, whether or not an amusement sticker in which a photograph of one or more persons is taken is created, or whether or not a photograph is created by use of an image taken with a mobile telephone.

10. The image processing apparatus according to claim 3, wherein the application information indicates whether or not a identification photograph of a single person is created, whether or not an amusement sticker in which a photograph of one or more persons is taken is created, or whether or not a photograph is created by use of an image taken with a mobile telephone.

11. A print system comprising:
the image processing apparatus of claim 1; and
a printer which prints the image processed by the image processing apparatus on a predetermined paper.

12. A print system comprising:
the image processing apparatus of claim 3; and
a printer which prints the image processed by the image processing apparatus on a predetermined paper.

13. The print system according to claim 11, further comprising a camera with which a photograph of a person is taken, wherein the image processing apparatus performs the correction of the image obtained by use of the camera.

14. The print system according to claim 12, further comprising a camera with which a photograph of a person is taken, wherein the image processing apparatus performs the correction of the image obtained by use of the camera.
